(19) United States
(12) Patent Application Publication
(10) Pub. No.: US 2009/0077048 A1
(43) Pub. Date: Mar. 19, 2009

(54) METHOD AND SYSTEM FOR THE PROVISION OF SENSOR DATA

(76) Inventors: Vasco Vollmer, Bad Salzdetfurth (DE); Alexander Weber, Hildesheim (DE)

Correspondence Address: KENYON & KENYON LLP, ONE BROADWAY, NEW YORK, NY, 10004, US

(21) Appl. No.: 11/885,110

(22) PCT Filed: Feb. 24, 2006
(86) PCT No.: PCT/EP2006/060245

§ 371 Date: Oct. 1, 2008

(30) Foreign Application Priority Data
Feb. 25, 2005 (DE) 10 2005 008 714.0

(51) Int. Cl. G06F 7/06; G06F 17/30

(52) U.S. Cl. 707/4; 707/E17.014

(57) ABSTRACT

In a method and a system for providing data to a software application of a control unit, data emitted by a sensor are prepared in a data preparation module and the software application requests data required by it from a central information provider. The information provider retrieves data required for this from a data preparation module.

### FIELD OF THE INVENTION

The present invention relates to a method and a system for providing data to a software application of a control unit, in particular, a software application of control units present in motor vehicles.

### BACKGROUND INFORMATION

Highly integrated sensors are built into motor vehicles these days. They are either constructed as full-fledged users on the vehicle-wide, digital communications over dedicated bus systems, and, besides the actual sensor module, they usually have additionally a signal amplification module, an analog/digital converter and a microcontroller unit which makes possible dispatching messages onto the bus system or, as separate sensor modules, they are assigned directly to a control unit, which then undertakes the processing of the sensor values.

In addition to the highly integrated or separate sensors, control units are also connected to the bus system. Besides the obligatory bus controller, these essentially include an efficient processor which makes possible the execution of complex algorithms, and thus calculation-intensive software.

On the control units, usually software is executed (or software applications or just applications, from here on) which carries out calculations while having recourse to the data generated and emitted by the sensors, and undertakes the activation of actuators, as a function of the result. Such control unit arrangements are elementary components of today's vehicle systems, such as ESP (electronic stability program) for regulating slipping, TCS (traction control system) for traction control or ABS (antilock brake system) for brake control.

All the sensors present in the vehicle have to be known according to the applications of the specific model and the position, in order to be able to be queried correctly. In a similar manner, this knowledge has to be present also via the actuators that are present, in order to make possible their correct activation.

As a rule, the sensor data that are read in have to be prepared before further processing of the application. Sensor malfunctions and faulty values can be reliably detected by bringing together data of the same kind from different sensors. This bringing together of the same kind of sensor data is also designated in the technical world as “sensor fusion” or “sensor data fusion”. In addition, a software application can use aging characteristics curves of the respective sensor, in order to be able to detect and compensate for measured value deviations caused by deterioration processes.

The requirements for maintenance and development for software applications appear to be costly, and thus cost-intensive. What is therefore required is a structuring of the provision described of sensor data and data from other data sources on software applications of a control unit.

### SUMMARY

In the method according to example embodiments of the present invention for making available data to a software application of a control unit, data generated and emitted by a sensor or another data source are prepared in a data preparation module, while the software application requests the information it requires from an information provider, the information provider retrieving data required for this purpose from one or more data preparation modules.

Consequently, an aspect of example embodiments of the present invention relates to the preparation of data and the software applications. The data are prepared in one or more data preparation modules and may be stored temporarily. The data required by a software application are made available to this application by an information provider. To do this, the central information provider, or the information provider assigned to the respective application, communicates with one or more data preparation modules and passes on the assembled data to the software application.

Consequently, the method abstracts the hardware condition in the overall system, and thereby permits applications to read in data, especially from sensors, in a manner non-specific to hardware. One advantage is the simplified application development, because it is decoupled from the hardware, and the longer maintenance intervals that come about because of that. Whereas up to now the application had to have the intelligence concerning the preparation and further processing of sensor date in the control unit, and therefore the entire complex sensor technology had to be taken into consideration when the software was developed, because of example embodiments of the present invention, the individual applications can be relieved of this data preparation, whereby the development expenditure is considerably reduced. At the same time this results in a saving in calculating time, since the application only still has to execute the algorithm required for the actual activation of the actuator. But a saving in calculating time also occurs in general, since the preparation of the sensor data and other data from other data sources is still undertaken only once at a central location, instead of by each individual application.

The method and system according to example embodiments of the present invention reduce the maintenance requirement and the development requirement for applications, and thus the development costs and the life cycle costs. In addition, the sensors built into the motor vehicle and other data sources can be fully abstracted. This abstraction includes, for instance, a) manufacturer and model of the sensor, b) type and description of the provided information, c) position of the sensor or data source in the motor vehicle network, and permits the modification of just these parameters, without the need for modification of the application resulting from this.

One or more information providers may be assigned to one or more data preparation modules. For a certain software application, a pertaining (central) information provider can be specified, this central information provider being able to communicate with one or several of the other information providers. This has the advantage that the appertaining information provider for the respective software application can not only retrieve data from one or more data preparation modules, but also data from one or more other information providers.

In the following, the term “sensor” shall be used in lieu of a sensor or another data source. Accordingly, terms such as “sensor data” or “sensor control module” should not only be read as referring to sensors, but also as referring to other data sources.

Data generated or emitted by a sensor may be first preprocessed in a sensor control module that is assigned to the sensor. This will also be designated as sensor control module (SCM) below. The SCM may include software supplied by the manufacturer of the sensor. All that is known about the response behavior of the sensor, its specific aging characteristics line, the range of valid sensor data and other manufacturer-specific and model-specific sensor data can be stored in this location. The SCM is stationary and has direct or indirect access to the sensor.

It may furthermore be provided data preprocessed by one or more sensor control modules are stored in a data provision module, the preprocessed sensor data, e.g., being able to be further processed in this data provision module. This will also be designated below as data provision module (DPM). The DPM includes one or more SCM's. It supplements the slight functionality of the SCM's by additional self intelligence. Measured values sent by sensors or other data sources are temporarily stored by DPM and, depending on the applied-for requirement of the post-connected modules, are passed on to the latter or discarded upon arrival of the current follow-up measured values.

Whereas the sensor control modules (SCM) that were mentioned are assigned specifically to one certain sensor, a data provision module (DPM) can further process the data from one or more sensor control modules. The sensor control module and the data provision module are included in the above-mentioned data preparation module.

The information provider assigned to an application is used for data provision for a certain application. The information provider may also have available intelligence for further processing data or information. In particular, the information provider can process data of various data preparation modules and data provision modules (DPM) and/or several other information providers to form higher-valued information.

An information provider, also called information broker (IB) below, is used for data provision for applications. The DPM's supply the data present with them to the requesting IB in response to a targeted request. The IB provides both all the data received in this manner in their unprocessed (raw) variant, but it also may generate higher-valued data (information) from the incoming data. Such higher-valued data can be, for example, average values or even accumulated values. In addition, as was mentioned before, cross communication with one another is possible among the IB's, in order to obtain the values required for the calculation of the higher-valued data.

The application utilizes the provided (sensor) data and the information prepared from these (sensor) data in the algorithms implemented by the application. As a result, the application thus decides on the type and manner of activating the actuators, based on the incoming (sensor) data.

The system according to example embodiments of the present invention for providing (sensor) data to a software application of a control unit has a data preparation module for preparing data emitted by a sensor or another data source, an information provider being provided from which the software application requests or retrieves the information needed by it; this information provider being in contact with one or with several data preparation modules for data exchange.

Corresponding to the above-described method, this system yields the same advantages and embodiments in an analogous manner. For this, reference is made to the above. In particular, for simplicity, reference is made below to sensors as data sources.

If the system is implemented having a sensor control module (SCM) and a data provision module (DPM), this sensor control module can be either a component of the sensor assigned to it or a component of a control unit, the sensor control module being in contact with exactly one sensor, directly or (via a data bus) indirectly.

In principle, all the modules stated, namely the data preparation modules, the sensor control modules, the data provision modules, and also the information units can be implemented on one control unit or, separately, as individual bus users. Moreover, the modules and units can be implemented as software modules or as hardware modules. It may be provided that a data preparation module (DPM) and the central information unit (IB) are assigned as software modules on this control unit of the corresponding application.

In the following, the method and the system according to example embodiments of the present invention are explained in greater detail, with reference to the attached drawings.

### BRIEF DESCRIPTION OF THE DRAWINGS

FIG. 1 illustrates a network topology of a motor vehicle-wide network in schematic form.

FIG. 2 illustrates a system according to an example embodiment of the present invention with its modules for providing sensor data to a software application in a control unit.

### DETAILED DESCRIPTION

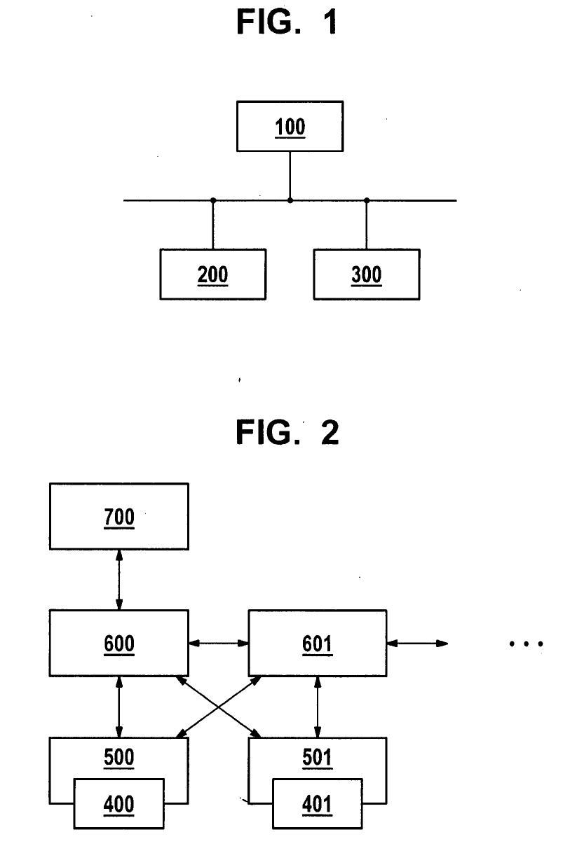

Example embodiments of present invention are explained in greater detail with reference to FIG. 1 and FIG. 2. FIG. 1 illustrates a network topology, devices on the network being denoted by reference numerals 100, 200 and 300 (denoted as network nodes below). Network node 100 represents a highly integrated sensor in this instance, while network nodes 200 and 300 each represent one control unit. Such networks are used particularly in motor vehicles, whereas in general, the network nodes can be subdivided into the three categories control units, sensors and actuators.

FIG. 2 schematically illustrates a system according to an example embodiment of the present invention, having a sensor control module (SCM) 400, a data provision module (DPM) 500, and information unit (IB) 600 as well as a software application 700. An additional information unit is designated as 601, an additional data provision module as 501 and an additional sensor control module as 401. Example embodiments of the present invention are described in connection with a motor vehicle network, with reference to FIGS. 1 and 2.

The sensors (sensor 100) pick up data concerning their surroundings and convert these data to currents. These analog data are usually amplified still in sensor 100, and are subsequently digitized. The digitized data are then passed on via a communications interface (in this case, the bus) to assigned control unit. Control unit 200 receives these data and passes them on to sensor control module (SCM) 400. In this exemplary embodiment, it follows that SCM 400 is a component of control unit 200. In each case, sensor 100 is connected to its appertaining SCM 400 directly or via the data bus. In SCM 400, the data are prepared such that they are usable for other components. This can include the use of various characteristics curves, for instance, for aging compensation and/or for temperature compensation, just as well as a validity check of the measured values. SCM 400 in this exemplary embodiment is not a stand-alone software module, but is closely connected to data provision module DPM 500. DPM 500 accepts the data processed by SCM 400 and then makes a decision on its further processing. In this instance, temporary storage may be provided, so that a request by an information unit 600, 601 is responded to in each case with the most updated data set. DPM 500 possesses enough self intelligence to execute error corrections, for example. Alternatively, DPM 500 can also assume the data preparations mentioned of SCM 400, such as aging compensation and/or temperature compensation.

If a request of an information unit (IB) 600, 601 is present according to the data present, the latter are passed on to IB 600, 601. If a request of IB 600, 601 is present that the data are to be transmitted periodically, DPM 500 monitors the period length via timer, and, upon expiration of the period length, dispatches the stored data to IB 600, 601. Newly arriving sensor values overwrite the values temporarily stored in DPM 500, in this instance.

An application 700 reports its requirement for sensor data or prepared data, to an information unit 600, which represents central information unit 600 for application 700. At an information unit 600, 601, there may be connected no DPM 500, 501, exactly one DPM 500, 501 or even more DPM's 500, 501, which are used as data sources. In this context, information unit 600 can provide both the data, available from DPM's 500, 501 connected to it, for application 700 and can also generate and provide higher-valued data, such as mean values, average values or summed values. Values calculated according to more complex formulas are also possible.

During the application of such formulas, if there is a demand for data in an information unit 600, 601 which are present in other information units 601, 600 that exist in parallel, these IB to IB communications are obtained.

The sequence shown above is described with reference to a specific example. Network node 100 will represent here a highly integrated sensor 100, which measures the environmental parameter (such as the environmental temperature) r₀ and sends it periodically to network node 200 every 10 ms. Let this network node 200 represent a control unit. The software architecture present on control unit 200 is shown by FIG. 2. In the present case, all the modules are designed as software modules, which are components of control unit 200. Control unit 200 records the sensor data directed to it, and passes them on to module 400 that is operated on it, namely sensor control module 400. On control unit 200, a plurality of sensor control modules can be used, but only a single sensor control module 400 is responsible for the processing of the parameter r₀ of sensor 100.

Sensor control module 400 refines the incoming sensor data r₀ to r₁, for instance, by the application of a aging characteristics curve for assigned sensor 100 and by a validity check of the received data. Data r₁ are subsequently passed on to data provision module 500. DPM 500 stores r₁ and also manages a register having sensor data requests of various information units 600, 601, . . . Consequently, there are four possibilities: a) information r₁ is not required; b) information r₁ is required exactly once; c) information r₁ is required periodically, having a length of period Δt; d) the information is required in selected numbers and at selected time intervals.

In this example, case c) is assumed, that is, there is a periodical demand for datum r₁. In addition, additional data are to be transmitted to application 700. DPM 500 awaits the expiration of an internal countdown timer having a starting value of Δt, and subsequently sends datum r₂ to the assigned information unit (IB) 600. IB 600 allows the data transmitted by data provision module 500 to enter into a formula k=r₂×s₁. s₁ is equal to information that is present on additional information unit 601. In order to obtain this information, IB 600 addresses IB 601 that is running on second control unit 300 and requests information s₁ that is generated there. Using the retrieved data r₂ and s₁, information unit 600, that is equipped with self intelligence, is able to calculate result k, and can subsequently export the data k, r₂, s₁ to application 700.

Example embodiments of the present invention are particularly suitable within the scope of complex new overall vehicle architectures, and is able to reduce the maintenance requirement and the development requirement for control unit applications, in this connection, and to lead to a significant savings in calculating time.

### REFERENCE NUMERALS

100 network node, sensor
200 network node, control unit
300 network node, control unit
400, 401 sensor control module (SCM)
500, 501 data provision module (DPM)
600, 601 information unit (IB)
700 application

1-19. (canceled)

20. A method for providing data to a software application of a control unit, comprising:
preparing data emitted by at least one of (a) a sensor and (b) another data source in a data preparation module;
requesting, by the software application, information required by the software application from an information provider; and
retrieving, by the information provider, data required by the software application from the data preparation module.

21. The method according to claim 20, wherein the information provider retrieves data from a plurality of data preparation modules.

22. The method according to claim 20, wherein at least one information provider is assigned to at least one data preparation module, each information provider communicating with at least one other information provider.

23. The method according to claim 20, wherein data emitted by at least one of (a) the sensor and (b) the another data source are first preprocessed in at least one of (a) a sensor control module and (b) a control module assigned to the at least one of (a) the sensor and (b) the another data source.

24. The method according to claim 23, wherein the preprocessed data are stored in a data provision module.

25. The method according to claim 24, wherein the preprocessed data are processed further in the data provision module.

26. The method according to claim 20, wherein the data transmitted to the information provider are further processed in the information provider and are subsequently provided to the software application.

27. A system for providing data to a software application of a control unit, comprising:
a data preparation module configured to prepare data emitted by at least one of (a) sensor and (b) another data source;
an information provider from which the software application requests the data required by the software application, the information provider connected to the data preparation module for exchange of data.

28. The system according to claim 27, wherein the information provider is connected to a plurality data preparation modules for data communication.

29. The system according to claim 27, wherein at least one information provider is assigned to at least one data preparation module, each information provider connected to at least one other information providers for data communication.

30. The system according to claim 27, further comprising at least one of (a) a sensor control module and (b) a control module assigned to at least one of (a) the sensor and (b) another data source configured to preprocess data emitted by the at least one of (a) the sensor and (b) the another data source, the at least one of (a) the sensor control module and (b) the control module arranged as a component of the data preparation module.

31. The system according to claim 30, further comprising a data provision module arranged as a component of the data preparation module and configured to store preprocessed data.

32. The system according to claim 27, wherein the data provision module is configured to further process the preprocessed data.

33. The system according to claim 27, wherein the information provider is configured to further process data transmitted to the information provider.

34. The system according to claim 30, wherein the sensor control module is arranged as a component of a respective sensor.

35. The system according to claim 30, wherein at least one of (a) the sensor control module and (b) the control module is arranged as a component of a control unit, the at least one of (a) the sensor control module and (b) the control module connected to exactly one of (a) a sensor and (b) another data source.

36. The system according to claim 28, wherein a data provision module is connected to at least one of (a) at least one sensor control module and (b) at least one control module for data communication.

37. The system according to claim 36, wherein a data provision module is arranged as a component of a control unit.

38. The system according to claim 27, wherein the information provider is arranged as a component of a control unit on which the software application is executed.
